(19) United States
(12) Patent Application Publication
(10) Pub. No.: US 2004/0166840 A1
(43) Pub. Date: Aug. 26, 2004

(54) Remote-control system including mobile radio-signal terminal

(75) Inventor: Masakazu Kawamura, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/783,237

(22) Filed: Feb. 20, 2004

(30) Foreign Application Priority Data
Feb. 20, 2003 (JP) 2003-042114

(51) Int. Cl. H04M 3/00

(52) U.S. Cl. 455/419

(57) ABSTRACT

The remote-control system includes a mobile radio-signal terminal, a data server, and a network allowing them to communicate with each other therethrough. The mobile radio-signal terminal includes a memory storing a plurality of remote-control codes therein, a signal transmitter transmitting a first remote-control signal to a target device, based on a remote-control code selected among the remote-control codes for causing the target device to carry out a desired operation, a signal receiver receiving a second remote-control signal from a terminal which remote-controls the target device, and a controller which determines a remote-control code, based on the received second remote-control signal, receives a set of remote-control codes from the data server, and stores the received remote-control codes in the memory. The data server receives the second remote-control signal, and transmits the set of remote-control codes associated with the target device, selected based on the second remote-control signal, to the mobile radio-signal terminal.

### BACKGROUND OF THE INVENTION

1. Field of the Invention

The invention relates to a mobile radio-signal terminal having a function of remote-controlling a target device, a remote-control system including the mobile radio-signal terminal, a method of storing remote-control data used for remote-controlling a target device, and a program to be installed in a mobile radio-signal terminal for causing a controller to carry out a method of storing remote-control data used for remote-controlling a target device.

2. Description of the Related Art

A mobile radio-signal terminal such as a cellular phone is recently designed to have not only a fundamental function of making oral communication with other mobile radio-signal terminals or telephones, but also a function of receiving various data, for instance, by downloading various applications. Such a mobile radio-signal terminal may be used for many purposes. For instance, there has been suggested a mobile radio-signal terminal having a function of remote-controlling a household electric appliance through remote-control signals.

Japanese Patent Application Publication No. 2002-199043 has suggested a mobile radio-signal terminal capable of remote-controlling an electronic device by receiving control data necessary for controlling the electronic device, from a data server through a communication network, converting the thus received control data into data having a format readable by the electronic device, and transmitting the converted data to the electronic device. For instance, the suggested mobile radio-signal terminal makes it possible to make reservation to a video tape recorder (VTR) for recording a television program, by receiving control data necessary for making reservation of recording a certain television program, from a data server, converting the received control data into data having a format suitable to the video tape recorder, and transmitting the converted data to the video tape recorder.

Japanese Patent Application Publication No. 2002-186063 has suggested a mobile radio-signal terminal designed to select and download a remote-control program associated with a target electronic device, from a server storing a plurality of remote-control programs therein, through Internet, and remote-control the target electronic device by means of the thus downloaded remote-control program. In accordance with the suggested mobile radio-signal terminal, a user can remote-control various electronic devices through a single mobile radio-signal terminal.

Japanese Patent Application Publication No. 2002-152856 has suggested a method of remote-controlling an electronic device, including the steps of making access to a domestic control unit equipped in a house, through a cellular phone while a user is out of his/her house, and causing the domestic control unit to transmit a control signal to a certain electronic device among a plurality of household electronic devices for remote-controlling the certain electronic device.

In the suggested method, when the domestic control unit is in a registration mode, the domestic control unit receives operation signals transmitted from remote-controllers associated with various household electronic devices, registers signal codes of the received operation signals into a table, and transmits data about the registered operation signals to a service administration server through Internet. Thereafter, if a user transmits a request to remote-control a certain electronic device, to the service administration server through his/her cellular phone through Internet, the service administration server transmits a control command used for remote-controlling the certain electronic device, to the domestic control unit through Internet in response to the user's request. On receipt of the control command, the domestic control unit reads a signal code included in the control command, out of the table, and transmits an operation signal associated with the signal code for remote-controlling the certain electronic device.

A commercially available multi-remote-controller is designed to drive devices manufactured by a plurality of manufactures. However, since remote-control formats for electronic devices to be remote-controlled are different from one another in accordance with a category and/or a manufacture, a user generally has to pre-set data about such a category and/or a manufacture into a remote-controller through keys. Similarly, the mobile radio-signal terminals suggested in the above-mentioned Japanese Patent Application Publications Nos. 2002-199043 and 2002-186063 are required to pre-set such data thereinto in advance. Hence, a user has to inspect a category and/or a manufacturer of an electronic device to be remote-controlled, and input data indicative of them into the mobile radio-signal terminals.

When a user pre-sets the data into the mobile radio-signal terminals, a user has to repeatedly carry out pre-set operation to select one of remote-control data among a lot of remote-control data associated with categories and manufactures. Hence, pre-set operation is burdensome for a user of the mobile radio-signal terminals suggested in the above-mentioned Japanese Patent Application Publications Nos. 2002-199043 and 2002-186063.

In addition, the mobile radio-signal terminals suggested in the Publications are accompanied with problems that they cannot store therein remote-control data of all categories and manufactures due to a limited capacity of a memory, and that a user has to pay charges each time he/she downloads latest control data into his/her mobile radio-signal terminal through a network.

The method suggested in the above-mentioned Japanese Patent Application Publication No. 2002-152856 is accompanied with a problem that since a mobile radio-signal terminal is not used as a remote-controller terminal, but the domestic administration unit is used as a remote-controller terminal, the domestic administration unit has to be prepared apart from a service administration server arranged in a network, resulting in complexity in the system. Furthermore, even in the method suggested in Japanese Patent Application Publication No. 2002-152856, a user has to receive data used for identifying a category of remote-control, through a network, and pre-set the thus received data into his/her mobile radio-signal terminal. In addition, even if devices to be remote-controlled belong to a common category, a user has to take a difference in a manufacturer and/or a manufacture year into consideration, and hence, pre-set operation is unavoidably complicated.

Japanese Patent Application Publication No. 2001-285945 has suggested a cellular phone system including a cellular phone, a distribution center which distributes remote-control codes, and a network through which the cellular phone and the distribution center makes communication with each other. The distribution center stores therein remote-control codes associated with a plurality of remote-control signals. The cellular phone is comprised of a memory storing remote-control codes distributed by the distribution center, a reader which reads a designated remote-control code out of the memory, and a converter which converts the thus read-out remote-control code into a remote-control signal used for driving a target device.

Japanese Patent Application Publication No. 2002-95073 has suggested a remote-control code setting system including a server, and a mobile terminal into which a remote-control code associated with a household electric appliance is input through a network, in order to user the mobile terminal as a remote-controller. The server includes a memory storing remote-control codes associated with various household electric appliances, and a transmitter which reads a remote-control code associated with a manufacturer code and a category code of a target household electric appliance which remote-control code is transmitted from the mobile terminal, out of the memory, and transmits the thus read-out remote-control code to the mobile terminal. The mobile terminal is comprised of a code transmitter which transmits a manufacturer code and a category code of a household electric appliance to the server, a receiver which receives a remote-control code associated with the manufacturer code and the category code having been transmitted from the transmitter of the server, a remote-control code register which registers the remote-control code having been received by the receiver, and a remote-control code transmitter which reads the remote-control code out of the remote-control code register, and transmits the remote-control code to an associated household electric appliance.

Japanese Patent Application Publication No. 2002-271505 has suggested a mobile terminal having a remote-control function, including first means for acquiring data about a household electric appliance, second means for producing a control signal to be transmitted to a household electric appliance to be remote-controlled, based on the data having been acquired by the first means, and third means for transmitting the control signal to the household electric appliance.

### SUMMARY OF THE INVENTION

In view of the above-mentioned problems in the conventional mobile radio-signal terminals, it is an object of the present invention to provide a mobile radio-signal terminal, a remote-control system including the mobile radio-signal terminal, a method of storing remote-control data used for remote-controlling a target device, and a program to be installed in a mobile radio-signal terminal for causing a controller to carry out a method of storing remote-control data used for remote-controlling a target device, all of which are capable of automatically carrying out pre-set operation without necessity of a user to manually carry out pre-set operation.

It is also an object of the present invention to provide such a mobile radio-signal terminal, a remote-control system, a method and a program as mentioned above all of which are capable of minimizing a volume of remote-control data to be downloaded for carrying out pre-set operation, to thereby prevent a user from being unnecessarily charged.

It is further an object of the present invention to provide such a mobile radio-signal terminal, a remote-control system, a method and a program as mentioned above all of which are minimizing a capacity of a memory in which remote-control data is to be stored.

In accordance with the present invention, if a user transmits one remote-control data selected among a lot of remote-control data, to a network for downloading data necessary for carrying out pre-set operation, the network analyzes the received remote-control data, identifies an optimal set of remote-control data including the received remote-control data, and transmits the optimal set of remote-control data to a user's mobile radio-signal terminal. The mobile radio-signal terminal carries out pre-set operation in accordance with the received set of remote-control data.

In one aspect of the present invention, there is provided a remote-control system including a mobile radio-signal terminal, a data server, and a network allowing the mobile radio-signal terminal and the data server to communicate with each other therethrough, wherein the mobile radio-signal terminal includes (a) a memory storing a plurality of remote-control codes therein, (b) a signal transmitter which transmits a first remote-control signal to a target device, based on a remote-control code selected among the remote-control codes for causing the target device to carry out a desired operation, (c) a signal receiver which receives a second remote-control signal indicative of a certain operation, from a terminal which remote-controls the target device, and (d) a controller which (d1) determines a remote-control code, based on the second remote-control signal having been received by the signal receiver, (d2) receives a set of remote-control codes from the data server, and (d3) stores the thus received set of remote-control codes in the memory as the plurality of remote-control codes, and wherein the data server receives the second remote-control signal, and transmits the set of remote-control codes associated with the target device and selected in accordance with the second remote-control signal, to the mobile radio-signal terminal.

In the remote-control system in accordance with the present invention, the mobile radio-signal terminal receives the second remote-control signal indicative of a certain operation, transmitted from a terminal used for remote-controlling a target device, and transmits a remote-control code associated with the received second remote-control signal, to the data server through a network. On receipt of the remote-control code, the data server identifies specification of the target device such as a category, a manufacture and/or a manufacture year, and transmits a set of remote-control codes associated with the target device, to the mobile radio-signal terminal. The mobile radio-signal terminal stores the thus received set of remote-control codes in the memory. Hence, for instance, only if a user actuates a predetermined key of the terminal used for remote-controlling the target device, the set of remote-control codes such s a category and/or a manufacturer of the target device is all pre-set in the memory at a time.

As mentioned above, for instance, the set of remote-control codes include at least a category and a manufacturer of the target device.

The controller may further include a sampler which samples the second remote-control signal having been received by the signal receiver, and determines a remote-control code, based on the thus sampled second remote-control signal.

The controller may further include a signal producer which produces the first remote-control signal, based on the remote-control code having been read out of the memory.

For instance, the mobile radio-signal terminal is comprised of a cellular phone.

It is preferable that each of the first and second remote-control signals is comprised of infra-red rays, the signal transmitter is comprised of an infra-red ray irradiator, and the signal receiver is comprised of an infra-red ray receiver.

In another aspect of the present invention, there is provided a mobile radio-signal terminal having a function of making radio-signal communication with another radio-signal terminal through a network, including (a) a signal transmitter which transmits a first remote-control signal to a target device for remote-controlling the target device, (b) a signal receiver which receives a second remote-control signal indicative of a certain operation, from a terminal which remote-controls the target device, (c) a controller which obtains a remote-control code determined, based on the second remote-control signal having been received by the signal receiver, (d) a radio-signal transceiver which transmits the remote-control code to a data server through the network, and receives a set of remote-control codes used for remote-controlling the target device, from the data server through the network, and (e) a memory storing the set of remote-control codes having been received by the radio-signal transceiver, wherein the controller reads a remote-control code out of the memory for causing the target device to carry out a desired operation, transmits the thus read-out remote-control code to the signal transmitter, and causes the signal transmitter to produce the first remote-control signal.

The mobile radio-signal terminal in accordance with the present invention receives the second remote-control signal indicative of a certain operation, transmitted from a terminal used for remote-controlling a target device, and transmits a remote-control code associated with the received second remote-control signal, to the data server through a network. On receipt of the remote-control code, the data server identifies specification of the target device such as a category, a manufacture and/or a manufacture year, and transmits a set of remote-control codes associated with the target device, to the mobile radio-signal terminal. The mobile radio-signal terminal stores the thus received set of remote-control codes in the memory. Hence, for instance, only if a user actuates a predetermined key of the terminal used for remote-controlling the target device, the set of remote-control codes such s a category and/or a manufacturer of the target device is all pre-set in the memory at a time.

For instance, the set of remote-control codes include at least a category and a manufacturer of the target device.

The controller may further include a sampler which samples the second remote-control signal having been received by the signal receiver, and determines a remote-control code, based on the thus sampled second remote-control signal.

For instance, the mobile radio-signal terminal is comprised of a cellular phone.

It is preferable that each of the first and second remote-control signals is comprised of infra-red rays, the signal transmitter is comprised of an infra-red ray irradiator, and the signal receiver is comprised of an infra-red ray receiver.

In still another aspect of the present invention, there is provided a method of storing remote-control data used for remote-controlling a target device, including the steps of (a) transmitting a remote-control signal to a mobile radio-signal terminal, (b) transmitting the remote-control signal from the mobile radio-signal terminal to a data server, (c) identifying a target device to be remote-controlled, based on the remote-control signal, (d) identifying remote-control data used for remote-controlling the target device, among a plurality of remote-control stored in the data server, (e) transmitting the thus identified remote-control data to the mobile radio-signal terminal, and (f) storing the remote-control data in a memory equipped in the mobile radio-signal terminal.

For instance, the step (a) may be carried out by a user by actuating a predetermined key of a remote-controller used for remote-controlling the target device.

The method may further include the step of converting the remote-control signal into a digital signal, which is transmitted from the mobile radio-signal terminal to the data server.

For instance, the target device may be identified in the step (c) by identifying at least a category and a manufacturer of the target device.

It is preferable that the remote-control signal is transmitted to the mobile radio-signal terminal in the form of infra-red ray in the step (a).

The method may further include the step of transmitting the remote-control data from the mobile radio-signal terminal to the target device for remote-controlling the target device.

It is preferable that the remote-control data is transmitted to the target device in the form of infra-red ray.

In yet another aspect of the present invention, there is provided a program to be installed in a mobile radio-signal terminal for causing a controller to carry out a method of storing remote-control data used for remote-controlling a target device, steps executed by the controller in accordance with the program including (a) receiving a remote-control signal from a remote-controller used for remote-controlling the target device, (b) transmitting the remote-control signal to a data server, (c) receiving remote-control data used for remote-controlling the target device which remote-control data has been identified among a plurality of remote-control stored in the data server, and (d) storing the thus received remote-control data in a memory equipped in the mobile radio-signal terminal.

The steps may further include the step of converting the remote-control signal into a digital signal, which is transmitted to the data server.

The steps may further include the step of transmitting the remote-control data to the target device for remote-controlling the target device.

It is preferable that the remote-control data is transmitted to the target device in the form of infra-red ray.

The advantages obtained by the aforementioned present invention will be described hereinbelow.

In accordance with the present invention, a user can pre-set a set of remote-control data associated with a target device, into a memory merely by actuating a predetermined key of a terminal used for remote-controlling the target device. Hence, it is not necessary for a user to inspect a category and/or a manufacturer of the target device and input data indicative of them into a mobile radio-signal terminal. In addition, it is not necessary for a user neither to repeatedly carry out pre-set operation to select one of remote-control data among a lot of remote-control data associated with categories and manufactures. A user can complete pre-set operation merely by directing the terminal towards the mobile radio-signal terminal and transmitting a remote-control signal to the mobile radio-signal terminal.

In addition, a user can complete complicated pre-set operation without being conscious of the pre-set operation by downloading the latest remote-control data into his/her mobile radio-signal terminal from the data server through a network. This ensures remarkable reduction in charges for carrying out pre-set operation. Furthermore, since a user can pre-set the necessary remote-control data into a memory without downloading data a plurality of times, avoiding unnecessarily being charged.

In accordance with the present invention, it is not necessary for the mobile radio-signal terminal to store remote-control codes associated with all manufactures and all categories, into a memory. Hence, it is possible to reduce a capacity of a memory.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a mobile radio-signal terminal in accordance with the embodiment of the present invention.

FIG. 2 is a block diagram of a remote-control system including the mobile radio-signal terminal in accordance with the embodiment of the present invention, illustrated in FIG. 1.

FIG. 3 is a flow-chart showing steps to be carried out in the operation of the remote-control system illustrated in FIG. 2.

### DESCRIPTION OF THE PREFERRED EMBODIMENT

A preferred embodiment in accordance with the present invention will be explained hereinbelow with reference to drawings.

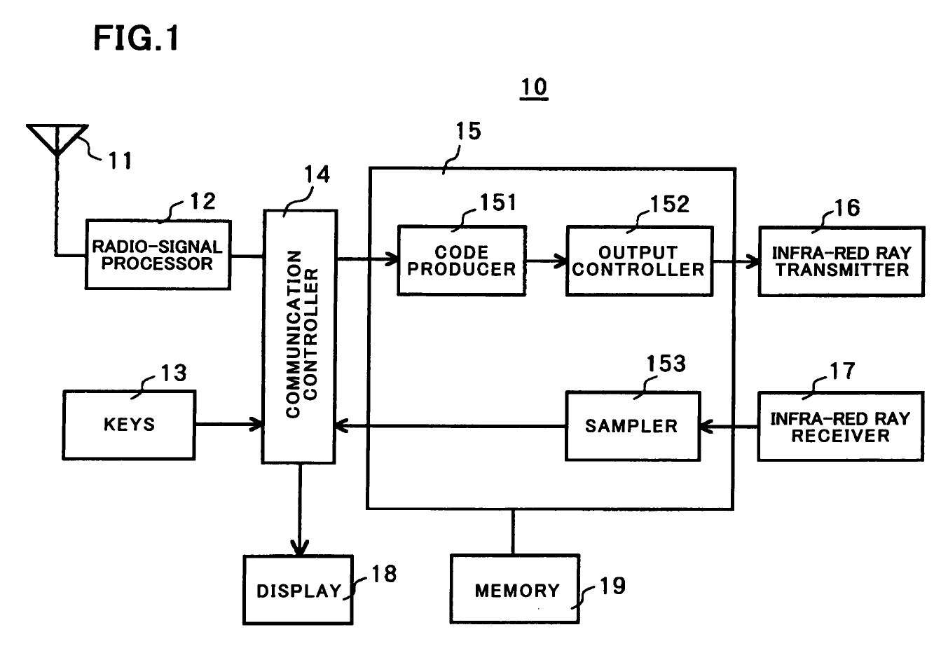

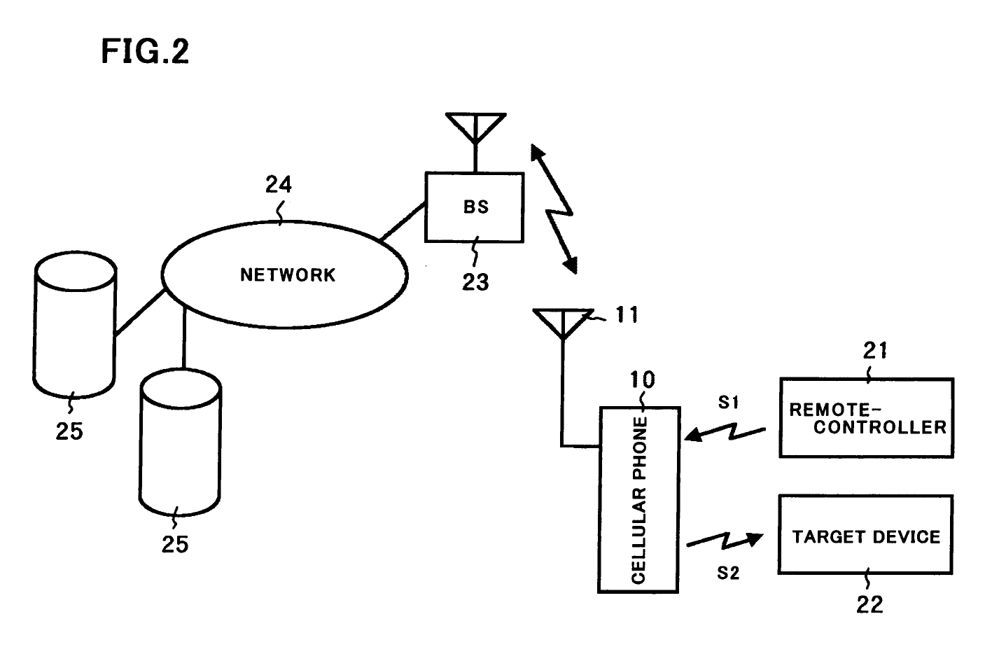

FIG. 1 is a block diagram of a mobile radio-signal terminal in accordance with the embodiment of the present invention, and FIG. 2 is a block diagram of a remote-control system including the mobile radio-signal terminal.

The mobile radio-signal terminal in accordance with the embodiment is comprised of a cellular phone 10.

As illustrated in FIG. 1, the cellular phone 10 is comprised of an antenna 11, a radio-signal processor 12 making radio-signal communication with a closest base station 23 (see FIG. 2) through the antenna 11, a plurality of keys 13 through which a user can input data into the cellular phone 10, a communication controller 14 controlling parts of the cellular phone 10 for making radio-signal communication, a remote-control unit 15 which controls an operation of a target device 22 (see FIG. 2), an infra-red ray transmitter 16 which transmits a remote-control signal in the form of infra-red ray, an infra-red ray receiver 17 which receives an infra-red ray signal transmitted from a remote-controller 21 (see FIG. 2) used for remote-controlling the target device 22, a display 18 for displaying images therein, and a memory 19 storing remote-control data therein.

The remote-control unit 15 is comprised of a code producer 151 which produces a transmission code, based on remote-control data stored in the memory 19, an output controller 152 which controls transmission of the transmission code to the infra-red ray transmitter 16, and a sampler 153 which digitally samples a waveform of a signal having been received at the infra-red ray receiver 17.

The communication controller 14 has functions of controlling receipt of data from the radio-signal processor 12 and transmission of data to the radio-signal processor 12, and controlling an operation of the keys 13 and the display 18. That is, the communication controller 14 controls an operation of the cellular phone 10 when the cellular phone 10 is used for making radio-signal communication with others.

As illustrated in FIG. 2, the remote-control system is comprised of the cellular phone 10 illustrated in FIG. 1, a base station 23 making radio-signal communication with the cellular phone 10, a data server 25, and a wired network 24 through which the base station 23 and the data server 25 make communication with each other. Thus, the cellular phone 10 can make communication with the data server 25 through the base station 23 and the network 24.

The target device 22 is comprised of a household electric appliance such as a television set, radio or an electric heater, for instance. The remote-controller 21 is a device used for remote-controlling the target device 22.

As illustrated in FIG. 2, the cellular phone 10 receives an infra-red ray signal from the remote-controller 21 through the infra-red ray receiver 17, and transmits an infra-red ray signal as a remote-control signal to the target device 22 through the infra-red ray transmitter 16.

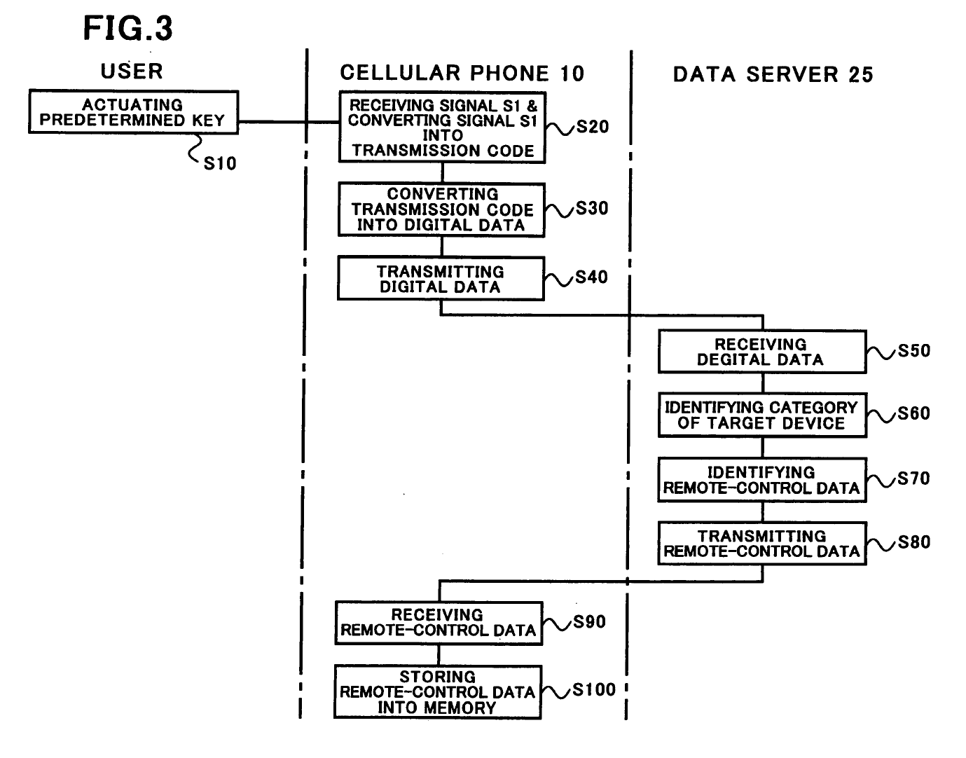

FIG. 3 is a flow-chart showing steps to be carried out for pre-setting remote-control data.

Hereinbelow are explained operations of the remote-control system and the cellular phone 10 for pre-setting remote-control data, with reference to FIGS. 1 to 3.

A user actuates a predetermined key of the remote-controller 21 to transmit an infra-red ray signal S1 to the cellular phone 10, in step S10. For instance, a user actuates a key for turning a power source of the remote-controller 21 on.

The infra-red ray receiver 17 of the cellular phone 10 receives the infra-red ray signal S1 transmitted from the remote-controller 21, and converts the thus received infra-red ray signal S1 into a transmission code comprised of an electric signal, in step S20. Then, the transmission code is transmitted to the sampler 153, in which the transmission code is converted into digital data, in step S30.

The sampler 153 transmits the thus converted digital data to the communication controller 14. The communication controller 14 transmits the digital data through the radio-signal processor 12 and the antenna 11, in step S40.

The data server 25 receives the digital data as remote-control data indicative of a certain operation, through the base station 23 and the network 24, in step S50.

The data server 25 extracts various data such as a modulation frequency and a custom code out of the received remote-control data. Then, the data server 25 identifies a category and a manufacturer of the target device 22 to be remote-controlled, based on the thus extracted modulation frequency, custom code and other data, in step S60. Then, the data server 25 identifies all remote-control data suitable for remote-controlling the target device 22 among a lot of remote-control data stored therein, in step S70. Herein, remote-control data includes a modulation frequency, a data format, a custom code and a control code for each of operation control, for instance.

The thus identified remote-control data covers a category, a manufacture year and a manufacturer of the target device 22, and is comprised of transmission codes associated with all of remote-control operations including the remote-control operation indicated by the infra-red ray signal S1. The data server 25 transmits the thus identified remote-control data to the mobile radio-signal terminal 10 through the network 24 and the base station 23, in step S80.

The mobile radio-signal terminal 10 receives the remote-control data transmitted from the data server 25, through the antenna 11 and the radio-signal processor 12, in step S90, and then, the communication controller 14 stores the thus received remote-control data into the memory 19 through the remote-control unit 15, in step S100.

Thus, the pre-set operation is completed.

Hereinbelow is explained a detailed example of the pre-set operation.

It is assumed that the target device 22 is a television set manufactured by a manufacture X and having a certain model number, and that the remote-controller 21 is associated with the television set and used for remote-controlling the television set.

A user directs the remote-controller 21 towards the cellular phone 10, and actuates a “power on” key to transmit the infra-red ray signal S1 to the cellular phone 10.

The infra-red ray receiver 17 of the cellular phone 10 receives the infra-red ray signal S1 transmitted from the remote-controller 21, and converts the thus received infra-red ray signal S1 into a transmission code. Then, the transmission code is transmitted to the sampler 153, in which the transmission code is converted into digital data.

The sampler 153 transmits the thus converted digital data to the communication controller 14. The communication controller 14 transmits the digital data to the data server 25 through the radio-signal processor 12 and the antenna 11.

The data server 25 receives the digital data as remote-control data indicative of the “power on” operation, through the base station 23 and the network 24.

The data server 25 analyzes the received remote-control data, and knows that the target device 22 is a television set manufactured by the manufacturer X and having a certain model number. Then, the data server 25 identifies all remote-control data used for remote-controlling the target device 22, including data for controlling a power source of the target device 22, data for sound-volume control, and so on.

Then, the data server 25 transmits the thus identified remote-control data to the mobile radio-signal terminal 10 through the network 24 and the base station 23.

The mobile radio-signal terminal 10 stores the thus received remote-control data into the memory 19 through the remote-control unit 15.

Accordingly, in accordance with the embodiment, a user can pre-set a set of remote-control data associated with a target device 22, including a category and a manufacturer of the target device 22, into the memory 19 at a time merely by actuating a “power on” key of the remote-control terminal 21. Hence, it is not necessary for a user to inspect a category and/or a manufacturer of the target device 22 and input data indicative of them into the memory 19. In addition, it is not necessary for a user to repeatedly carry out the pre-set operation to select one of remote-control data among a lot of remote-control data associated with various categories and manufactures. A user can complete the pre-set operation merely by directing the remote-control terminal 21 towards the mobile radio-signal terminal 10 and transmitting the remote-control signal S1 to the mobile radio-signal terminal 10.

Hereinbelow is explained an operation of the mobile radio-signal terminal 10 for remote-controlling the target device 22.

When a key for remote-controlling the target device 22, among a plurality of the keys 13, is actuated, the remote-control unit 15 reads remote-control data out of the memory 19, based on information transmitted from the keys 13 through the communication controller 14. Then, the code producer 151 produces transmission code associated with the received remote-control data.

The thus produced transmission code is transmitted to the output controller 152, which then converts the transmission code to a remote-control signal having a predetermined format. The thus converted remote-control signal is transmitted to the infra-red ray transmitter 16.

The infra-red ray transmitter 16 transmits the remote-control signal S2 in the form of an infra-red ray to the target device 22.

As a result, a remote-control operation associated with the key having been actuated by a user is carried out to the target device 22.

As explained above, in accordance with the embodiment, a user can complete complicated pre-set operation without being conscious of the pre-set operation by downloading the latest remote-control data into his/her mobile radio-signal terminal 10 from the data server 25 through the network 24. This ensures remarkable reduction in charges for carrying out pre-set operation. Furthermore, since a user can pre-set the necessary remote-control data into a memory without downloading data a plurality of times, avoiding unnecessarily being charged.

The memory 19 may have a capacity sufficient to store only necessary remote-control data, and is not necessary to have a capacity to store remote-control data associated with all of manufacturers and categories. Hence, the memory 19 can be designed to have a small capacity.

Though the mobile radio-signal terminal in the above-mentioned embodiment is comprised of the cellular phone 10, it should be noted that the embodiment may be applied to a mobile radio-signal terminal other than a cellular phone. For instance, the embodiment may be applied to a personal handy phone system (PHS) or a mobile communication terminal such as a personal digital assistant (PDA).

In addition, the remote-control signals S1 and S2 are not to be limited to infra-red ray signals. The remote-control signals S1 and S2 may be comprised of a ultrasonic signal and so on.

In the above-mentioned embodiment, remote-control operation of the target device 22 is triggered by actuation of a predetermined key among the keys 13. However, it should be noted that remote-control operation of the target device 22 may be triggered by inputting a trigger signal into the cellular phone 10 from another terminal through a network.

The remote-control unit 15 has such a structure as mentioned above, and operates in such a manner as mentioned above.

An operation of remote-control unit 15 can be accomplished by a computer program written in a language readable by a computer.

For operating remote-control unit 15 by means of a computer program, remote-control unit 15 is designed to include a memory to store a computer program therein, for instance. The computer program is stored in the memory, and is read out into remote-control unit 15 when remote-control unit 15 starts its operation. Thus, such an operation of remote-control unit 15 as mentioned above is accomplished in accordance with the computer program.

As an alternative, a recording medium storing such a computer program as mentioned above may be set into remote-control unit 15 to be read out by remote-control unit 15.

The functions of remote-control unit 15 may be accomplished as a program including various commands, and be presented through a recording medium readable by a computer.

In the specification, the term “recording medium” means any medium which can record data therein.

The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A recording medium storing a program for accomplishing remote-control unit 15 may be accomplished by programming functions of remote-control unit 15 with a programming language readable by a computer, and recording the program in a recording medium such as mentioned above.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-042114 filed on Feb. 20, 2003 including specification, claims, drawings and summary is incorporated herein by reference in its entirety.

What is claimed is:

1. A remote-control system including a mobile radio-signal terminal, a data server, and a network allowing said mobile radio-signal terminal and said data server to communicate with each other therethrough,
wherein said mobile radio-signal terminal includes:
(a) a memory storing a plurality of remote-control codes therein;
(b) a signal transmitter which transmits a first remote-control signal to a target device, based on a remote-control code selected among said remote-control codes for causing said target device to carry out a desired operation;
(c) a signal receiver which receives a second remote-control signal indicative of a certain operation, from a terminal which remote-controls said target device; and
(d) a controller which (d1) determines a remote-control code, based on said second remote-control signal having been received by said signal receiver, (d2) receives a set of remote-control codes from said data server, and (d3) stores the thus received set of remote-control codes in said memory as said plurality of remote-control codes, and
wherein said data server receives said second remote-control signal, and transmits said set of remote-control codes associated with said target device and selected in accordance with said second remote-control signal, to said mobile radio-signal terminal.

2. The remote-control system as set forth in claim 1, wherein said set of remote-control codes include at least a category and a manufacturer of said target device.

3. The remote-control system as set forth in claim 1, wherein said controller further includes a sampler which samples said second remote-control signal having been received by said signal receiver, and determines a remote-control code, based on the thus sampled second remote-control signal.

4. The remote-control system as set forth in claim 1, wherein said controller includes a signal producer which produces said first remote-control signal, based on said remote-control code having been read out of said memory.

5. The remote-control system as set forth in claim 1, wherein said mobile radio-signal terminal is comprised of a cellular phone.

6. The remote-control system as set forth in claim 1, wherein each of said first and second remote-control signals is comprised of infra-red rays, said signal transmitter is comprised of an infra-red ray irradiator, and said signal receiver is comprised of an infra-red ray receiver.

7. A mobile radio-signal terminal having a function of making radio-signal communication with another radio-signal terminal through a network, including:
(a) a signal transmitter which transmits a first remote-control signal to a target device for remote-controlling said target device;
(b) a signal receiver which receives a second remote-control signal indicative of a certain operation, from a terminal which remote-controls said target device;
(c) a controller which obtains a remote-control code determined, based on said second remote-control signal having been received by said signal receiver;
(d) a radio-signal transceiver which transmits said remote-control code to a data server through said network, and receives a set of remote-control codes used for remote-controlling said target device, from said data server through said network; and
(e) a memory storing said set of remote-control codes having been received by said radio-signal transceiver,
wherein said controller reads a remote-control code out of said memory for causing said target device to carry out a desired operation, transmits the thus read-out remote-control code to said signal transmitter, and causes said signal transmitter to produce said first remote-control signal.

8. The mobile radio-signal terminal as set forth in claim 7, wherein said set of remote-control codes include at least a category and a manufacturer of said target device.

9. The mobile radio-signal terminal as set forth in claim 7, wherein said controller includes a sampler which samples said second remote-control signal having been received by said signal receiver, and determines a remote-control code, based on the thus sampled second remote-control signal.

10. The mobile radio-signal terminal as set forth in claim 7, wherein said mobile radio-signal terminal is comprised of a cellular phone.

11. The mobile radio-signal terminal as set forth in claim 7, wherein each of said first and second remote-control signals is comprised of infra-red rays, said signal transmitter is comprised of an infra-red ray irradiator, and said signal receiver is comprised of an infra-red ray receiver.

12. A method of storing remote-control data used for remote-controlling a target device, comprising the steps of:
(a) transmitting a remote-control signal to a mobile radio-signal terminal;
(b) transmitting said remote-control signal from said mobile radio-signal terminal to a data server;
(c) identifying a target device to be remote-controlled, based on said remote-control signal;
(d) identifying remote-control data used for remote-controlling said target device, among a plurality of remote-control stored in said data server;
(e) transmitting the thus identified remote-control data to said mobile radio-signal terminal; and
(f) storing said remote-control data in a memory equipped in said mobile radio-signal terminal.

13. The method as set forth in claim 12, wherein said step (a) is carried out by a user by actuating a predetermined key of a remote-controller used for remote-controlling said target device.

14. The method as set forth in claim 12, further comprising the step of converting said remote-control signal into a digital signal, which is transmitted from said mobile radio-signal terminal to said data server.

15. The method as set forth in claim 12, wherein said target device is identified in said step (c) by identifying at least a category and a manufacturer of said target device.

16. The method as set forth in claim 12, wherein said remote-control signal is transmitted to said mobile radio-signal terminal in the form of infra-red ray in said step (a).

17. The method as set forth in claim 12, further comprising the step of transmitting said remote-control data from said mobile radio-signal terminal to said target device for remote-controlling said target device.

18. The method as set forth in claim 17, wherein said remote-control data is transmitted to said target device in the form of infra-red ray.

19. A program to be installed in a mobile radio-signal terminal for causing a controller to carry out a method of storing remote-control data used for remote-controlling a target device, steps executed by said controller in accordance with said program including:
(a) receiving a remote-control signal from a remote-controller used for remote-controlling said target device;
(b) transmitting said remote-control signal to a data server;
(c) receiving remote-control data used for remote-controlling said target device which remote-control data has been identified among a plurality of remote-control stored in said data server; and
(d) storing the thus received remote-control data in a memory equipped in said mobile radio-signal terminal.

20. The program as set forth in claim 19, wherein said steps further include the step of converting said remote-control signal into a digital signal, which is transmitted to said data server.

21. The program as set forth in claim 19, wherein said steps further include the step of transmitting said remote-control data to said target device for remote-controlling said target device.

22. The program as set forth in claim 19, wherein said remote-control data is transmitted to said target device in the form of infra-red ray.
